(19) United States
(12) Patent Application Publication
(10) Pub. No.: US 2019/0222020 A1
(43) Pub. Date: Jul. 18, 2019

(54) Protection Circuit for Ethernet and Power Sourcing Equipment Having the Same

(71) Applicant: NLightning Technology Ltd., Zhubei City (TW)

(72) Inventors: Kun Tsen Lin, Zhubei City (TW); Shih Peng Wu, Zhubei City (TW)

(21) Appl. No.: 16/153,889

(22) Filed: Oct. 8, 2018

(30) Foreign Application Priority Data
Jan. 12, 2018 (TW) 107200596

(51) Int. Cl. H02H 9/04; H02H 7/20

(52) U.S. Cl. CPC H02H 9/046; H02H 7/20; H02H 9/044

(57) ABSTRACT

A protection circuit for Ethernet and a power sourcing equipment having the same are provided. The protection circuit is coupled between a power supply chip and a transmission circuit. The transmission circuit is coupled between an Ethernet chip and an Ethernet connector. The protection circuit includes a diode assembly and a protection component to provide the common mode surge protection and the differential mode surge protection at the same time for the power supply chip.

This application claims priority to Taiwan Patent Application No. 107200596 filed on Jan. 12, 2018, which is hereby incorporated by reference in its entirety.

### CROSS-REFERENCES TO RELATED APPLICATIONS

Not applicable.

### BACKGROUND OF THE INVENTION

### Field of the Invention

The present invention relates to a protection circuit for Ethernet. More particularly, the protection circuit of the present invention can be installed in a power sourcing equipment for a Power over Ethernet (PoE) system to provide a surge protection for the power sourcing equipment.

### Descriptions of the Related Art

Ethernet related products have become necessities in people's daily life. The power over Ethernet (PoE) equipment has many applications in life as well. The PoE equipment can be classified into two different types of device: a power sourcing equipment (PSE) and a powered device (PD). The PSE provides direct current (DC) power and/or network communication to the PDs. However, the PSE is vulnerable to the surge (e.g., thunderstroke surge) since the PSE is usually connected to the outdoor web camera or other PDs in order to save extra cost of wiring the power lines.

Accordingly, an urgent need exists in the art to provide a surge protection circuit or a surge protection device which can provide both common mode surge protection and differential mode surge protection to prevent the Ethernet PSE from being damaged by the surge.

### SUMMARY OF THE INVENTION

An objective of the present invention is to provide a protection circuit for Ethernet and a power sourcing equipment having the same. The protection circuit can provide the Ethernet PSE with both common mode surge protection function and differential mode surge protection function to prevent the Ethernet PSE from being damaged by the surge (e.g., thunderstroke surge) when being used in the outdoor environment.

To achieve the aforesaid objective, the present invention discloses a protection circuit for Ethernet. The protection circuit is configured to be coupled between a power supply chip and a transmission circuit. The transmission circuit is coupled between an Ethernet chip and an Ethernet connector. The protection circuit comprises a first input pin, a second input pin, a first output pin, a second output pin, a first ground pin, a first diode assembly and a first protection component. The first input pin is configured to be coupled to the power supply chip. The second input pin is configured to be coupled to the power supply chip. The first output pin is configured to be coupled to a first transmission component set of the transmission circuit. The second output pin is configured to be coupled to a second transmission component set of the transmission circuit. The first ground pin is configured to be coupled to a ground terminal. The first diode assembly is configured to be coupled between the first input pin and the second input pin. A first coupling point between two diodes of the first diode assembly is further configured to be coupled to the first ground pin. The first protection component is coupled between the first output pin and the second output pin.

Moreover, the present invention further discloses a power sourcing equipment for Ethernet. The power sourcing equipment comprises an Ethernet chip, an Ethernet connector, a transmission circuit, a power supply chip and a protection circuit. The transmission circuit is coupled between the Ethernet chip and the Ethernet connector. The protection circuit is coupled between a power supply chip and a transmission circuit. The protection circuit comprises a first input pin, a second input pin, a first output pin, a second output pin, a first ground pin, a first diode assembly and a first protection component. The first input pin is configured to be coupled to the power supply chip. The second input pin is configured to be coupled to the power supply chip. The first output pin is configured to be coupled to a first transmission component set of the transmission circuit. The second output pin is configured to be coupled to a second transmission component set of the transmission circuit. The first ground pin is configured to be coupled to a ground terminal. The first diode assembly is configured to be coupled between the first input pin and the second input pin A first coupling point between two diodes of the first diode assembly is further configured to be coupled to the first ground pin. The first protection component is coupled between the first output pin and the second output pin.

The detailed technology and preferred embodiments implemented for the present invention are described in the following paragraphs accompanying the appended drawings for people skilled in this field to well appreciate the features of the claimed invention.

### BRIEF DESCRIPTION OF THE DRAWINGS

FIG. 1 is an implementation scenario of the protection circuit 1 according to the present invention;

FIGS. 2-3 are schematic views of the protection circuit 1 according to the present invention;

FIGS. 4-5 are schematic views of the protection circuit 1 according to the present invention;

FIG. 6 is an implementation scenario of the protection circuit 1 according to the present invention;

FIG. 7 is an implementation scenario of the protection circuit 1 according to the present invention;

FIGS. 8-9 are schematic views of the protection circuit 1 according to the present invention;

FIG. 10 is an implementation scenario of the protection circuit 1 according to the present invention;

FIG. 11 is a schematic view of the protection circuit 1 according to the present invention; and

FIG. 12 is a schematic view of the protection circuit 1 according to the present invention.

### DESCRIPTION OF THE PREFERRED EMBODIMENT

Embodiments described below are intended to illustrate technical contents of the present invention but not to limit the scope of the present invention. It shall be appreciated that, in the following embodiments and the attached drawings, components not related to the present invention are omitted from depiction, and dimensional relationships among individual components in the drawings are only provided for ease of understanding but not to limit the actual scale.

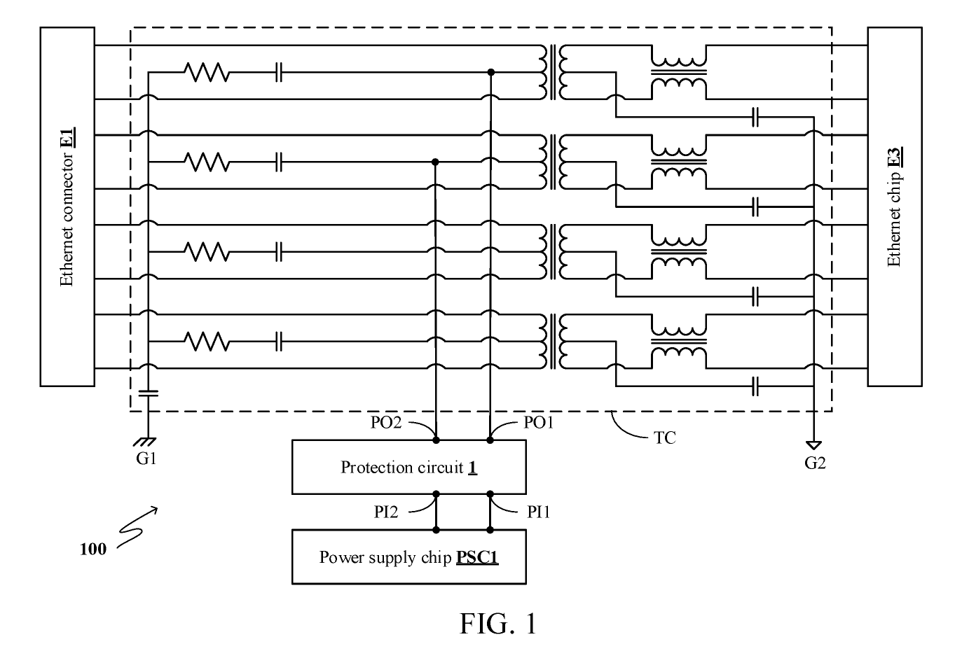

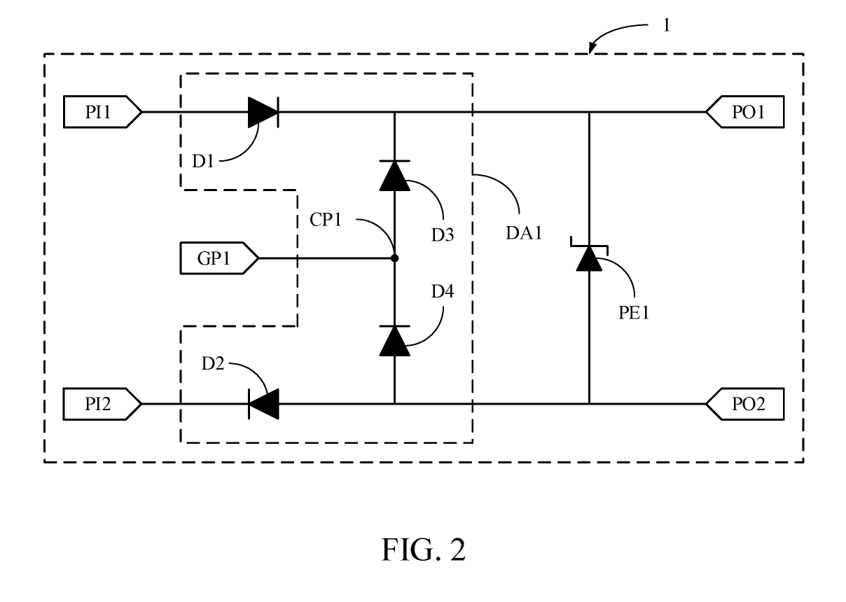

A first embodiment of the present invention is shown in FIG. 1 and FIG. 2. FIG. 1 is an implementation scenario of the protection circuit 1 according to the present invention. The protection circuit 1 can be installed into a power sourcing equipment (PSE) 100 for a Power over Ethernet (PoE) system. The PSE 100 comprises a protection circuit 1, a transmission circuit TC, a power supply chip PSC1, an Ethernet chip E3 and an Ethernet connector E1. The protection circuit 1 is coupled between the power supply chip PSC1 and the transmission circuit TC. The transmission circuit TC is coupled between the Ethernet chip E3 and the Ethernet connector E1. It shall be appreciated that, for simplifying the description, other components of the PSE 100 such as the housing, the power supply module and other components irrelevant to the present invention are omitted from depiction in the drawings.

The Ethernet connector E1 may be an Ethernet connector having an RJ-45 interface, which may include a TX0+ pin, a TX0− pin, a TX1+ pin, a TX1− pin, a TX2+ pin, a TX2− pin, a TX3+ pin, and a TX3− pin. The transmission circuit TC may comprise four transformer components which correspond to four twisted pair and are individually connected between the Ethernet connector E1 and the Ethernet chip E3. The Ethernet chip E3 may be a chip from any chip manufacturer, e.g., the RTL8201 chip from Realtek Semiconductor Corporation, which may include a MD0+ pin, a MD0− pin, a MD1+ pin, a MD1− pin, a MD2+ pin, a MD2− pin, a MD3+ pin, and a MD3− pin. Because the main technical contents of the present invention focus on the protection circuit 1, and the connection relationship among the protection circuit 1 of the present invention, the Ethernet connector E1, the Ethernet chip E3 and the power supply chip PSC1 will be readily appreciated by those of ordinary skill in the art based on the following descriptions, such connection relationship will not be further described herein.

FIG. 2 is a schematic view of the protection circuit 1 according to the present invention. The protection circuit 1 comprises a first input pin PI1, a second input pin PI2, a first output pin PO1, a second output pin PO2, a first ground pin GP1, a first diode assembly DA1 and a first protection component PE1. The first input pin PI1 is configured to be coupled to a positive terminal of the power supply chip PSC1. The second input pin PI2 is configured to be coupled to a negative terminal of the power supply chip PSC1. The first diode assembly DA1 is configured to be coupled between the first input pin PI1 and the second input pin PI2. A coupling point CP1 between two diodes of the first diode assembly DA1 is further configured to be coupled to the first ground pin GP1. In this embodiment, the first diode assembly DA1 comprises a first diode D1, a second diode D2, a third diode D3 and a fourth diode D4. However, in other embodiments, one of the first diode D1 and the second diode D2 can be omitted and the function of the protection circuit twill still work.

The first output pin PO1 is configured to be coupled to a first transmission component set of the transmission circuit TC. The second output pin PO2 is configured to be coupled to a second transmission component set of the transmission circuit TC. In detail, the transmission circuit TC includes four transmission component sets, each of which includes a transformer having a center tap. The first output pin PO1 is coupled to the center tap of the transformer of the first transmission component set, and the second output pin PO2 is coupled to the center tap of the transformer of the second transmission component set. The first ground pin GP1 is configured to be coupled to a ground terminal G1. It shall be appreciated that, the ground terminal G1 refers to the ground of the housing of the device (i.e., the external ground); however, the ground terminal G2 refers to the common ground (i.e., the internal ground), usually a voltage of which is 0 V.

It shall be appreciated that, the drawings of the present application are taking the top two transmission component sets of the transmission circuit TC as the first transmission component set and the second transmission component set as example. However, the words “first” and “second” used in the aforesaid terms “the first transmission component set” and “the second transmission component set” are only used to distinguish the different transmission component sets, but not to limit the ordering of the transmission component sets. In practical application, the supplier and the manufacturer of the protection circuit 1 can decide which transmission component set is the first transmission component set or the second transmission component set for different needs. For example, the supplier or the manufacturer can take the top transmission component set and the bottom transmission component set as the first transmission component set and the second transmission component set, respectively.

The first diode D1 is forward coupled from the first input pin PI1 to the first output pin PO1. The second diode D2 is inversely coupled from the second input pin PI2 to the second output pin PO2. The fourth diode D4 is forward connected in series with the third diode D3. The third diode D3 and the fourth diode D4 are coupled between the first diode D1 and the second diode D2. The coupling point CP1 between the third diode D3 and the fourth diode D4 is configured to be coupled to the first ground pin GP1.

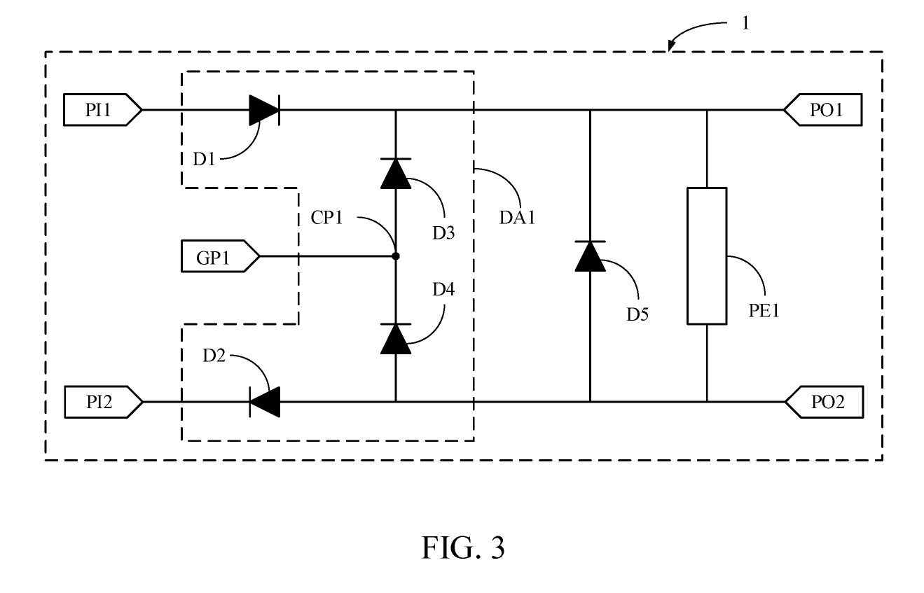

In this embodiment, the first protection component PE1 is coupled between the first output pin PO1 and the second output pin PO2. For example, the first protection component PE1 is a unidirectional transient voltage suppressor (TVS) diode. However, in other embodiments, the first protection component PE1 may be one of a bidirectional TVS diode, a thyristor, a gas discharge tube and a voltage dependent resistor (VDR), and the protection circuit 1 further comprises a fifth diode DS which is coupled in parallel with the first protection component PE1 and coupled between the first output pin PO1 and the second output pin PO2, as shown in FIG. 3.

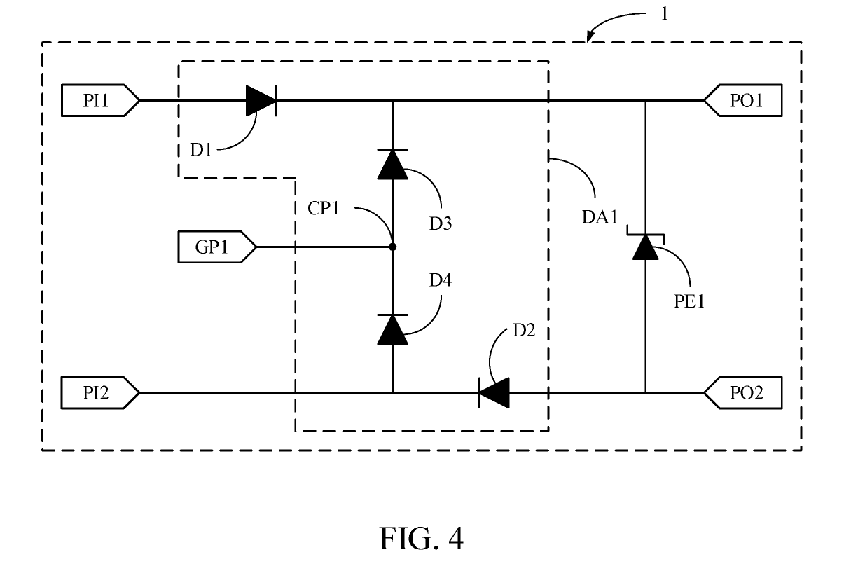

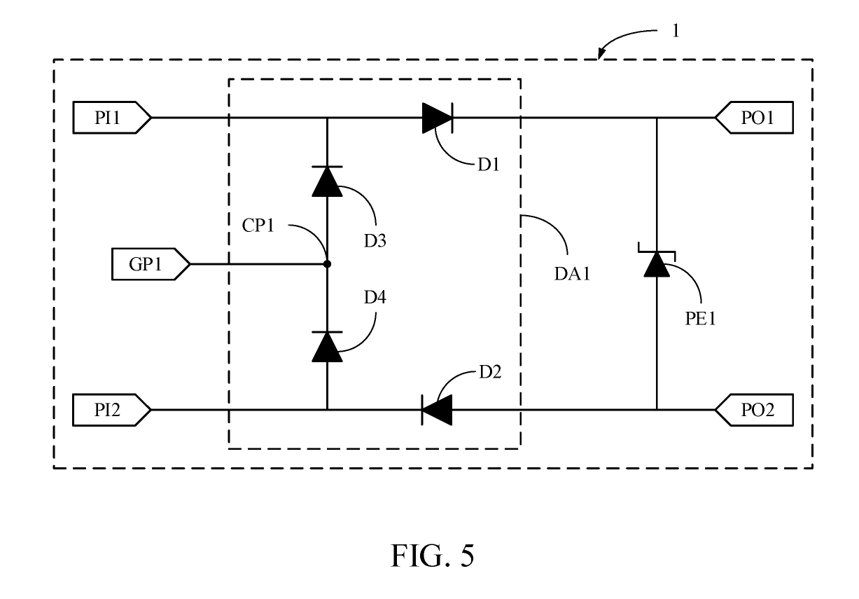

It shall be appreciated that, in the protection circuit 1, except for the position of the first protection component PE1 that has to be the closest to the first output pin PO1 and the second output pin PO2, the relative positions of the rest components (i.e., the diodes) can be changed. For example, as shown in FIG. 4, the second diode D2 in the protection circuit 1 can be moved to be closer to the second output pin PO2 than the fourth diode D4. In another example, as shown in FIG. 5, the third diode D3 and the fourth diode D4 in the protection circuit 1 can be moved to be closest to the first input pin PI1 and the second input pin PI2. Similarly, the configuration of the protection circuit 1 in FIG. 3 can be changed in the same way.

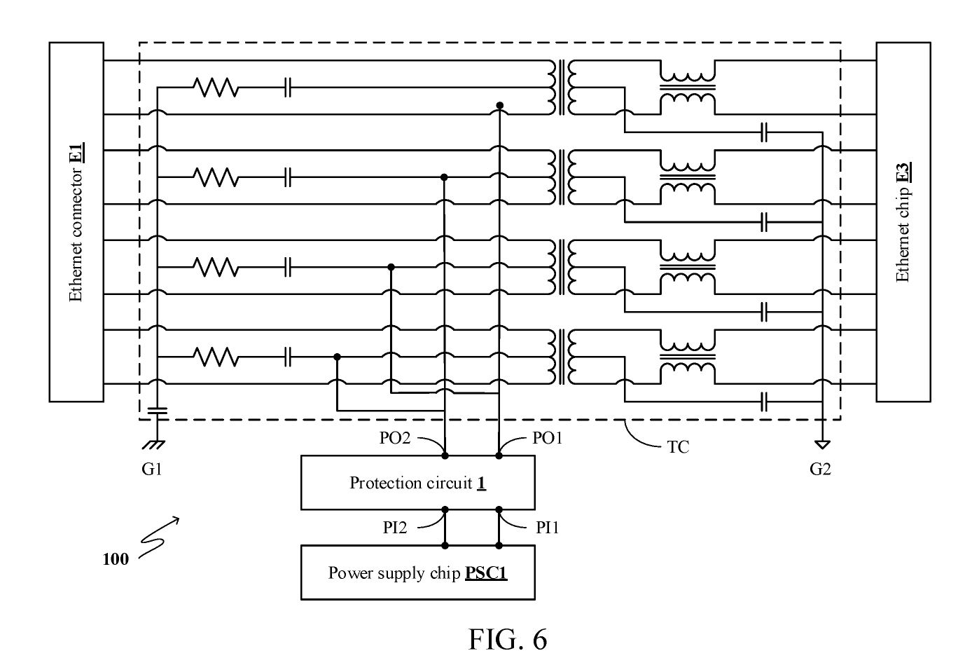

A second embodiment of the present invention is as shown in FIG. 6. In this embodiment, the first output pin PO1 of the protection circuit 1 is further coupled to a third transmission component set (i.e., the center tap of the transformer of the third transmission component set) of the transmission circuit TC, and the second output pin PO2 is further coupled to a fourth transmission component set (i.e., the center tap of the transformer of the fourth transmission component set) of the transmission circuit TC.

It shall be appreciated that, similarly, the words “first,” “second,” “third,” and “fourth” of the aforesaid terms “first transmission component set,” “the second transmission component set,” “the third transmission component set” and “the fourth transmission component set” are only used to distinguish the different transmission component sets, but not to limit the ordering of the transmission component sets. How to arrange these transmission component set in the transmission circuit TC and couple the output pins of the protection circuit 1 to the corresponding transmission component sets in response to various applications shall be appreciated by those of ordinary skill in the art based on the above descriptions, and thus will not be further described herein.

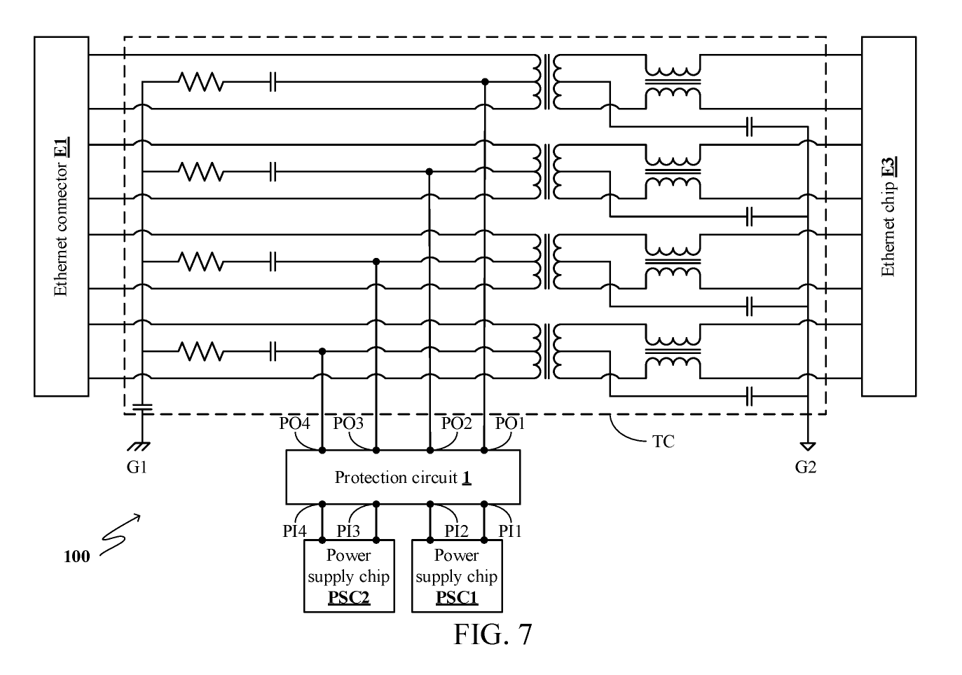

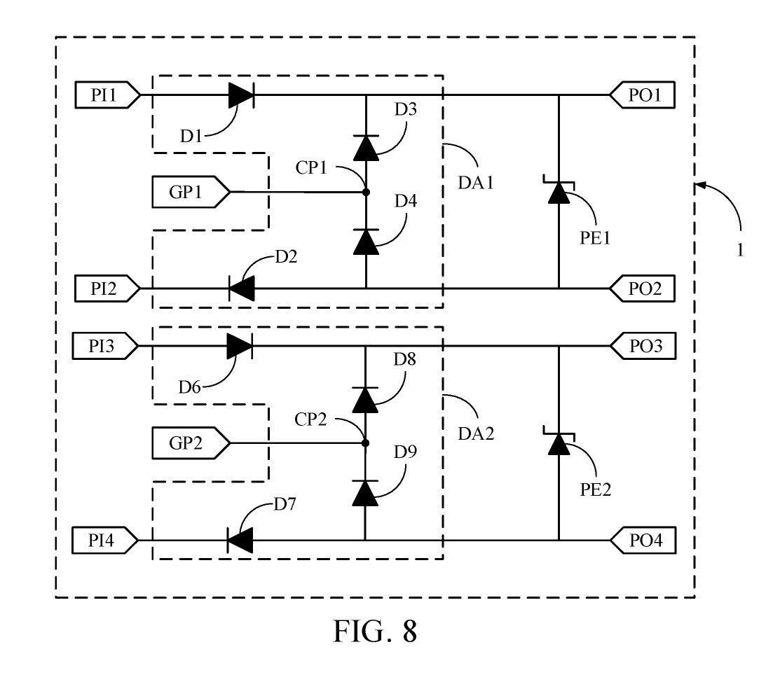

A third embodiment of the present invention is as shown in FIGS. 7-8. The third embodiment is an extension of the first embodiment. In this embodiment, the protection circuit 1 is further configured to be coupled between another power supply chip PSC2 and the transmission circuit TC, as shown in FIG. 7. Next, as shown in FIG. 8, the protection circuit 1 further comprises a third input pin PI3, a fourth input pin PI4, a third output pin PO3, a fourth output pin PO4, a second ground pin GP2, a second diode assembly DA2 and a second protection component PE2. The second diode assembly DA2 is configured to be coupled between the third input pin PI3 and the fourth input pin PI4, and the coupling point CP2 between two diodes of the second diode assembly DA2 is further configured to be coupled to the second ground pin GP2. In this embodiment, the second diode assembly DA2 comprises a sixth diode D6, a seventh diode D7, an eighth diode D8 and a ninth diode D9. Similarly, in other embodiments, one of the first diode D1 and the second diode D2 can be omitted and one of the sixth diode D6 and the seventh diode D7 can also be omitted without making the protection circuit 1 lose its function.

The third input pin PI3 is configured to be coupled to the positive terminal of the power supply chip PSC2. The fourth input pin PI4 is configured to be coupled to the negative terminal of the power supply chip PSC2. The third output pin PO3 is configured to be coupled to a third transmission component set of the transmission circuit TC. The fourth output pin PO4 is configured to be coupled to a fourth transmission component set of the transmission circuit TC. Like the configuration in the first embodiment, the third output pin PO3 is coupled to the center tap of the transformer of the third transmission component set, and the fourth output pin PO4 is coupled to the center tap of the transformer of the fourth transmission component set. Similarly, the words “first,” “second,” “third,” and “fourth” of the aforesaid terms “first transmission component set,” “the second transmission component set,” “the third transmission component set” and “the fourth transmission component set” are only used to distinguish the different transmission component sets, but not to limit the ordering of the transmission component sets. How to arrange these transmission component set in the transmission circuit TC and couple the output pins of the protection circuit 1 to the corresponding transmission component sets in response to various applications shall be appreciated by those of ordinary skill in the art based on the above descriptions, and thus will not be further described herein.

The sixth diode D6 is forward coupled from the third input pin P13 to the third output pin PO3. The seventh diode D7 is inversely coupled from the fourth input pin P14 to the fourth output pin PO4. The ninth diode D9 is forward connected in series with the eighth diode D8. The eighth diode D8 and the ninth diode D9 are coupled between the sixth diode D6 and the seventh diode D7. The coupling point CP2 between the eighth diode D8 and the ninth diode D9 is further configured to be coupled to the second ground pin GP2.

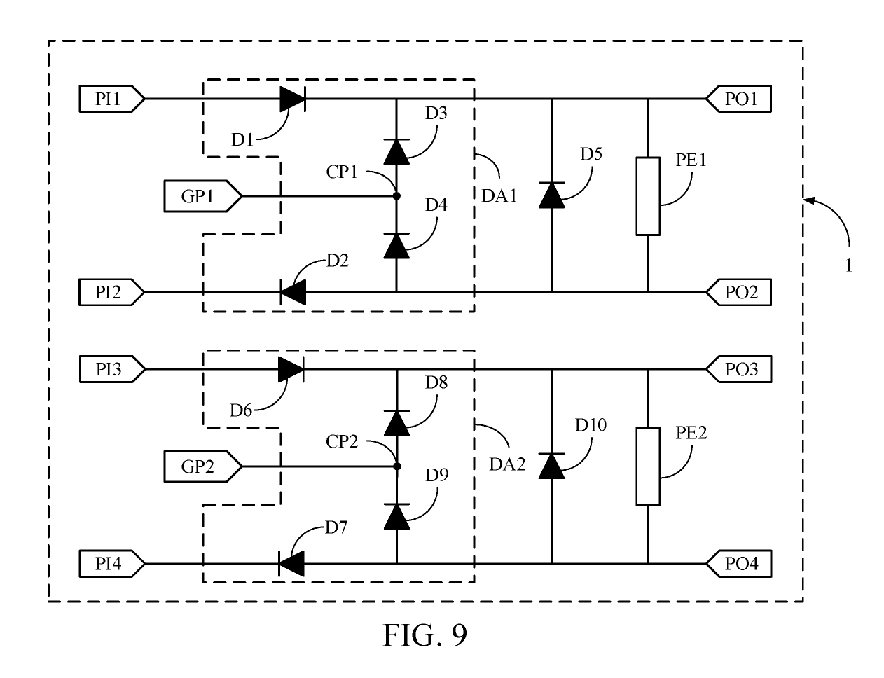

The second protection component PE2 is coupled between the third output pin PO3 and the fourth output pin PO4. In this embodiment, each of the first protection component PE1 and the second protection component PE2 is a unidirectional TVS diode, as shown in FIG. 8. However, in other embodiments, each of the first protection component PE1 and the second protection component PE2 is one of a bidirectional TVS diode, a thyristor, a gas discharge tube and a VDR, and the protection circuit 1 further comprises a fifth diode DS and a tenth diode D10, as shown in FIG. 9. The fifth diode DS is coupled in parallel with the first protection component PE1 and coupled between the first output pin PO1 and the second output pin PO2. The tenth diode D10 is connected in parallel with the second protection component PE2 and coupled between the third output pin PO3 and the fourth output pin PO4.

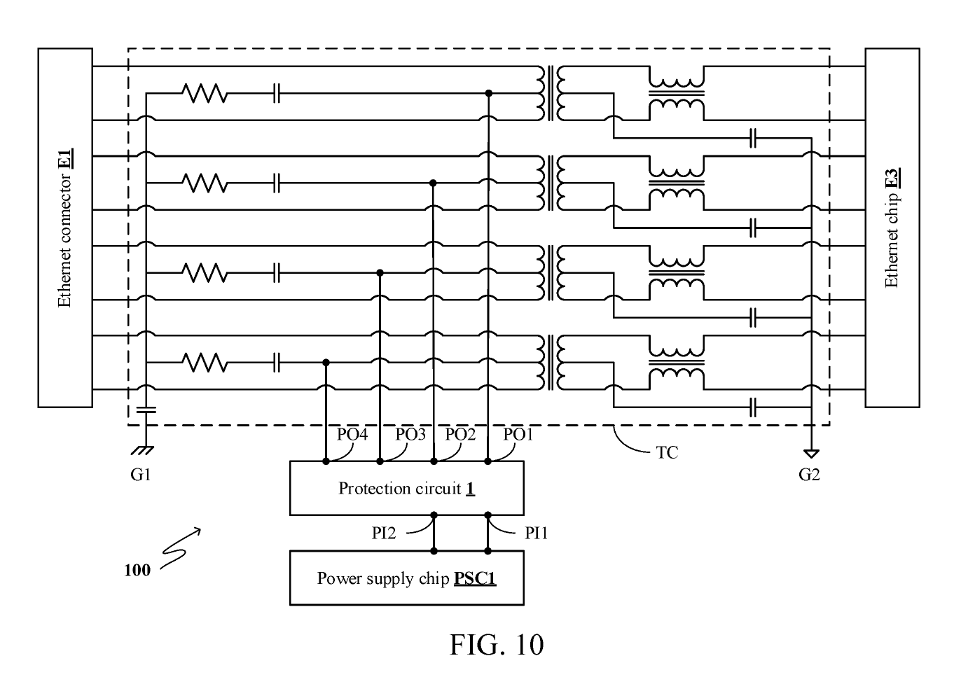

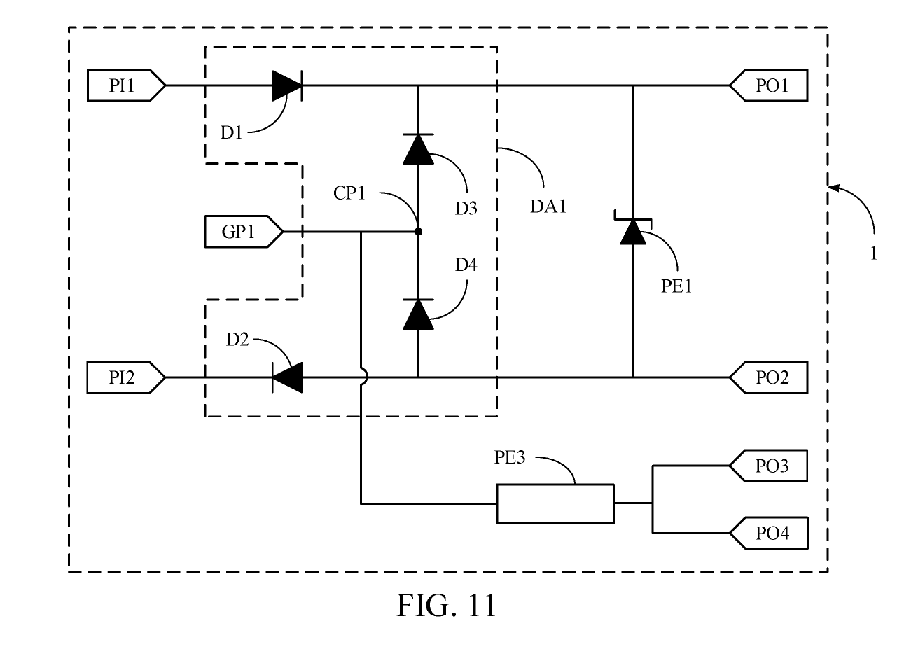

A fourth embodiment of the present invention is as shown in FIGS. 10-11. The fourth embodiment is an extension of the first embodiment. In this embodiment, the protection circuit 1 further comprises the third output pin PO3, the fourth output pin PO4 and the second protection component PE2. The third output pin PO3 is configured to be coupled to a third transmission component set of the transmission circuit TC. The fourth output pin PO4 is configured to be coupled to a fourth transmission component set of the transmission circuit TC. The second protection component PE2 is configured to couple the third output pin PO3 and the fourth output pin PO4 to the first ground pin GP1. In this embodiment, the second protection component PE2 is one of a unidirectional TVS diode, a bidirectional TVS diode, a thyristor, a gas discharge tube and a VDR.

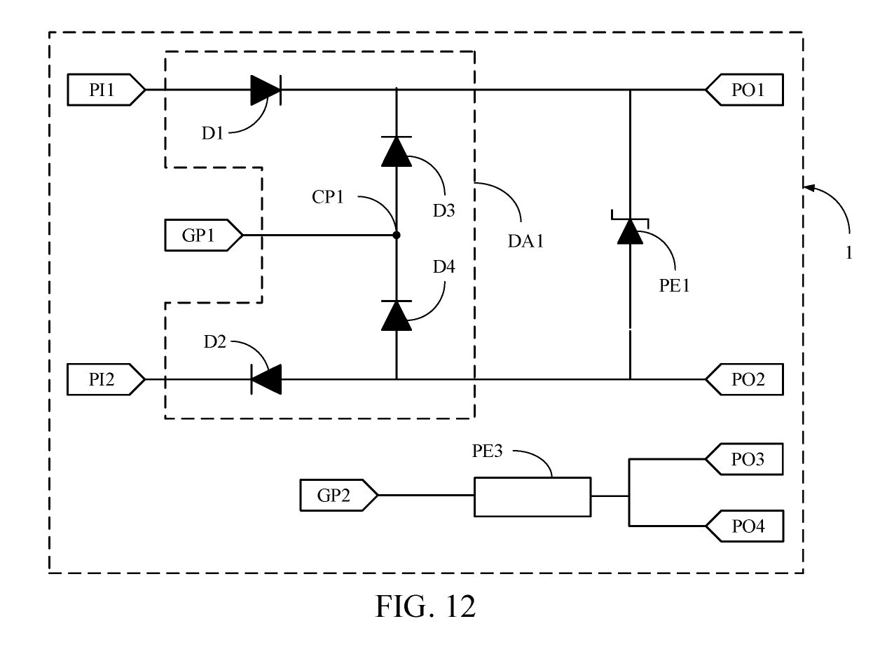

A fifth embodiment of the present invention is as shown in FIGS. 10 and 12. Unlike the fourth embodiment, in this embodiment, the protection circuit 1 further comprises the second ground pin GP2 which is configured to be coupled to the ground terminal G1, and the second protection component PE2 is configured to couple the third output pin PO3 and the fourth output pin PO4 to the second ground pin GP2.

According to the above descriptions, the protection circuit of the present invention can provide the power supply chip with both common mode surge protection and differential mode surge protection. To be more specific, to prevent the common mode surge and the differential mode surge from entering the power supply chip, the protection circuit provides a path to the ground for the common mode surge, and directs the differential mode surge, which comes from one output pin, to the other output pin through the first protection component or the fifth diode. Compare to the conventional protection circuit, the protection circuit of the present invention can use fewer electronic components and reduce the cost. In addition, the protection circuit can be further packaged into a single component and integrated into Ethernet connector socket to significantly save space on the printed circuit board (PCB). Besides, if other electronic devices behind the protection circuit are also connected to the power supply chip, the protection circuit of the present invention can also protect these electronic devices at the same time from being damaged by the common mode surge and the differential mode surge.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A protection circuit for Ethernet, configured to be coupled between a power supply chip and a transmission circuit, the transmission circuit being coupled between an Ethernet chip and an Ethernet connector, the protection circuit comprising:
a first input pin, being configured to be coupled to the power supply chip;
a second input pin, being configured to be coupled to the power supply pin;
a first output pin, being configured to be coupled to a first transmission component set of the transmission circuit;
a second output pin, being configured to be coupled to a second transmission component set of the transmission circuit;
a first ground pin, being configured to be coupled to a ground terminal;
a first diode assembly, being configured to be coupled between the first input pin and the second input pin, wherein a first coupling point between two diodes of the first diode assembly is further configured to be coupled to the first ground pin; and
a first protection component, being coupled between the first output pin and the second output pin.

2. The protection circuit of claim 1, wherein the first diode assembly comprises:
a first diode, being forward coupled from the first input pin to the first output pin;
a second diode, being inversely coupled from the second input pin to the second output pin;
a third diode; and
a fourth diode, being forward connected in series with the third diode, wherein the third diode and the fourth diode are coupled between the first diode and the second diode, and the first coupling point between the third diode and the fourth diode is configured to be coupled to the first ground pin.

3. The protection circuit of claim 1, wherein the first output pin is further coupled to a third transmission component set of the transmission circuit, and the second output pin is further coupled to a fourth transmission component set of the transmission circuit.

4. The protection circuit of claim 1, wherein the first protection component is a unidirectional transient voltage suppressor (TVS) diode.

5. The protection circuit of claim 1, wherein the first protection component is one of a bidirectional TVS diode, a thyristor, a gas discharge tube and a voltage dependent resistor (VDR), and the protection circuit further comprises:
a fifth diode, being coupled in parallel with the first protection component and coupled between the first output pin and the second output pin.

6. The protection circuit of claim 1, wherein the protection circuit is further configured to be coupled between another power supply chip and the transmission circuit, and the protection circuit further comprises:
a third input pin, being configured to be coupled to the another power supply chip;
a fourth input pin, being configured to be coupled to the another power supply chip;
a third output pin, being configured to be coupled to a third transmission component set of the transmission circuit;
a fourth output pin, being configured to be coupled to a fourth transmission component set of the transmission circuit;
a second ground pin, being configured to be coupled to the ground terminal;
a second diode assembly, being configured to be coupled between the third input pin and the fourth input pin, wherein a second coupling point between two diodes of the second diode assembly is further configured to be coupled to the second ground pin; and
a second protection component, being coupled between the third output pin and the fourth output pin.

7. The protection circuit of claim 6, wherein the second diode assembly comprises:
a sixth diode, being forward coupled from the third input pin to the third output pin;
a seventh diode, being inversely coupled from the fourth input pin to the fourth output pin;
an eighth diode; and
a ninth diode, being forward connected in series with the eighth diode, wherein the eighth diode and the ninth diode are coupled between the sixth diode and the seventh diode, and the second coupling point between the eighth diode and the ninth diode is further configured to be coupled to the second ground pin.

8. The protection circuit of claim 6, wherein each of the first protection component and the second protection component is a unidirectional TVS diode.

9. The protection circuit of claim 6, wherein each of the first protection component and the second protection component is one of a bidirectional TVS diode, a thyristor, a gas discharge tube and a VDR, and the protection circuit further comprises:
a fifth diode, being coupled in parallel with the first protection component and coupled between the first output pin and the second output pin; and
a tenth diode, being connected in parallel with the second protection component and coupled between the third output pin and the fourth output pin.

10. The protection circuit of claim 1, further comprising:
a third output pin, being configured to be coupled to a third transmission component set of the transmission circuit;
a fourth output pin, being configured to be coupled to a fourth transmission component set of the transmission circuit; and
a second protection component, being configured to couple the third output pin and the fourth output pin to the first ground pin.

11. The protection circuit of claim 10, wherein the second protection component is one of a unidirectional TVS diode, a bidirectional TVS diode, a thyristor, a gas discharge tube and a VDR.

12. The protection circuit of claim 1, further comprising:
a third output pin, being configured to be coupled to a third transmission component set of the transmission circuit;
a fourth output pin, being configured to be coupled to a fourth transmission component set of the transmission circuit;
a second ground pin, being configured to be coupled to the ground terminal; and
a second protection component, being configured to couple the third output pin and the fourth output pin to the second ground pin.

13. A power sourcing equipment for Ethernet, comprising:
an Ethernet chip;
an Ethernet connector;
a transmission circuit, being coupled between the Ethernet chip and the Ethernet connector;
a power supply chip; and
a protection circuit, being coupled between a power supply chip and a transmission circuit, and comprising:
a first input pin, being configured to be coupled to the power supply chip;
a second input pin, being configured to be coupled to the power supply pin;
a first output pin, being configured to be coupled to a first transmission component set of the transmission circuit;
a second output pin, being configured to be coupled to a second transmission component set of the transmission circuit;
a first ground pin, being configured to be coupled to a ground terminal;
a first diode assembly, being configured to be coupled between the first input pin and the second input pin, wherein a first coupling point between two diodes of the first diode assembly is further configured to be coupled to the first ground pin; and
a first protection component, being coupled between the first output pin and the second output pin.

14. The power sourcing equipment of claim 13, wherein the first diode assembly comprises:
a first diode, being forward coupled from the first input pin to the first output pin;
a second diode, being inversely coupled from the second input pin to the second output pin;
a third diode; and
a fourth diode, being forward connected in series with the third diode, wherein the third diode and the fourth diode are coupled between the first diode and the second diode, and the first coupling point between the third diode and the fourth diode is configured to be coupled to the first ground pin.

15. The power sourcing equipment of claim 13, wherein the first output pin is further coupled to a third transmission component set of the transmission circuit, and the second output pin is further coupled to a fourth transmission component set of the transmission circuit.

16. The power sourcing equipment of claim 13, wherein the first protection component is a unidirectional transient voltage suppressor (TVS) diode.

17. The power sourcing equipment of claim 13, wherein the first protection component is one of a bidirectional TVS diode, a thyristor, a gas discharge tube and a voltage dependent resistor (VDR), and the protection circuit further comprises:
a fifth diode, being coupled in parallel with the first protection component and coupled between the first output pin and the second output pin.

18. The power sourcing equipment of claim 13, wherein the protection circuit is further configured to be coupled between another power supply chip and the transmission circuit, and the protection circuit further comprises:
a third input pin, being configured to be coupled to the another power supply chip;
a fourth input pin, being configured to be coupled to the another power supply chip;
a third output pin, being configured to be coupled to a third transmission component set of the transmission circuit;
a fourth output pin, being configured to be coupled to a fourth transmission component set of the transmission circuit;
a second ground pin, being configured to be coupled to the ground terminal;
a second diode assembly, being configured to be coupled between the third input pin and the fourth input pin, wherein a second coupling point between two diodes of the second diode assembly is further configured to be coupled to the second ground pin; and
a second protection component, being coupled between the third output pin and the fourth output pin.

19. The power sourcing equipment of claim 18, wherein the second diode assembly comprises:
a sixth diode, being forward coupled from the third input pin to the third output pin;
a seventh diode, being inversely coupled from the fourth input pin to the fourth output pin;
an eighth diode; and
a ninth diode, being forward connected in series with the eighth diode, wherein the eighth diode and the ninth diode are coupled between the sixth diode and the seventh diode, and the second coupling point between the eighth diode and the ninth diode is further configured to be coupled to the second ground pin.

20. The power sourcing equipment of claim 18, wherein each of the first protection component and the second protection component is one of a bidirectional TVS diode, a thyristor, a gas discharge tube and a VDR, and the protection circuit further comprises:
a fifth diode, being coupled in parallel with the first protection component and coupled between the first output pin and the second output pin; and
a tenth diode, being connected in parallel with the second protection component and coupled between the third output pin and the fourth output pin.
